(19) United States
(12) Patent Application Publication
(10) Pub. No.: US 2026/0243946 A1
(43) Pub. Date: Aug. 20, 2026

(54) FABRICATION METHOD OF METAL NANOSTRUCTURE AND FIBER-OPTIC LOCALIZED SURFACE PLASMON RESONANCE SENSOR

(71) Applicant: Industry-Academic Cooperation Foundation, Dankook University, Gyeonggi-do (KR)

(72) Inventors: Seung-Ki Lee, Seoul (KR); Jae-Hyoung Park, Gyeonggi-do (KR); Hyeong-Min Kim, Gyeonggi-do (KR); Minseok Choo, Gyeonggi-do (KR); JongHyun Bang, Gyeonggi-do (KR)

(73) Assignee: Industry-Academic Cooperation Foundation, Dankook University, Gyeonggi-do (KR)

(21) Appl. No.: 19/417,334

(22) Filed: Dec. 12, 2025

(30) Foreign Application Priority Data
Feb. 17, 2025 (KR) 10-2025-0020340
Feb. 17, 2025 (KR) 10-2025-0020344

(51) Int. Cl. G02B 6/02; B82Y 20/00; G02B 1/00; G02B 5/00

(52) U.S. Cl. CPC G02B 6/0229; B82Y 20/00; G02B 1/002; G02B 5/008

(57) ABSTRACT

A fabrication method of a metal nanostructure includes attaching metal nanoparticles having a first size to a surface of an optical fiber treated with a first surface modifier by dipping the surface of the optical fiber into a first metal solution, forming a metal nanostructure by annealing the metal nanoparticles having the first size attached to the surface of the optical fiber, removing the first surface modifier existing on the surface of the optical fiber after the metal nanostructure is formed, through chemical treatment and/or physical treatment, treating the metal nanostructure formed on the surface of the optical fiber with a second surface modifier, and forming a multi-nanogap structure by dipping the metal nanostructure treated with the second surface modifier into a second metal solution and attaching metal nanoparticles having a second size to the metal nanostructure.

### CROSS-REFERENCE TO RELATED APPLICATION

This application claims the benefit of Korean Patent Application No. 10-2025-0020340, filed on February 17, 2025, and Korean Patent Application No. 10-2025-0020344, filed on February 17, 2025, in the Korean Intellectual Property Office, the entire disclosure of which is incorporated herein by reference for all purposes.

### BACKGROUND

### Field of the Invention

One or more embodiments relate to a fabrication method of a metal nanostructure and a fiber-optic localized surface plasmon resonance sensor using the metal nanostructure.

### Description of the Related Art

Surface plasmon resonance (SPR) refers to a phenomenon in which, when light is incident on an interface between a metal and a dielectric, free electrons on a metal surface resonate under specific conditions, causing electromagnetic waves to propagate along the metal surface. Such a SPR phenomenon occurs at specific wavelengths, which are influenced by a size, shape, and arrangement of the metal nanostructures and a refractive index of a surrounding medium.

The above information may be presented as the related art to help with the understanding of the disclosure. No arguments or decisions are raised to whether any of the above description is applicable as the prior art related to the present disclosure.

### SUMMARY

The disclosure may provide a method of forming a metal nanostructure used in a fiber-optic localized surface plasmon resonance (FO LSPR) sensor.

The disclosure may provide a method of fabricating a multi-nanogap structure by forming a metal nanostructure on a surface of an optical fiber through an annealing process and introducing the formed metal nanostructure and metal nanoparticles having different sizes.

The disclosure may provide a method of adjusting a size and arrangement of a metal nanostructure formed on a surface of an optical fiber through a multi-step annealing process.

However, the technical aspects are not limited to the aforementioned aspects, and other technical aspects may be present.

According to an aspect, there is provided a method of fabricating a metal nanostructure, the method including attaching metal nanoparticles having a first size to a surface of an optical fiber treated with a first surface modifier by dipping the surface of the optical fiber into a first metal solution, forming a metal nanostructure by annealing the metal nanoparticles having the first size attached to the surface of the optical fiber, removing the first surface modifier existing on the surface of the optical fiber after the metal nanostructure is formed, through chemical treatment and/or physical treatment, treating the metal nanostructure formed on the surface of the optical fiber with a second surface modifier, and forming a multi-nanogap structure by dipping the metal nanostructure treated with the second surface modifier into a second metal solution and attaching metal nanoparticles having a second size to the metal nanostructure.

The attaching may include forming a 3-aminopropylmethyldiethoxysilane (APMES) reactive group on the surface of the optical fiber by treating the surface of the optical fiber with the APMES.

The removing may include removing the APMES existing on the surface of the optical fiber using a sodium hydroxide (NaOH) solution.

The removing may include removing the APMES existing on the surface of the optical fiber through plasma treatment.

The treating may include treating the metal nanostructure formed on the surface of the optical fiber with cysteine to form an amine group on the surface of the metal nanostructure.

According to an aspect, there is provided a method of fabricating a metal nanostructure, the method including attaching metal nanoparticles to a surface of an optical fiber treated with a first surface modifier by dipping the surface of the optical fiber into a metal solution, forming a metal nanostructure by annealing the metal nanoparticles attached to the surface of the optical fiber, removing the first surface modifier existing on the surface of the optical fiber after the metal nanostructure is formed, through chemical treatment and/or physical treatment, treating the metal nanostructure formed on the surface of the optical fiber with a second surface modifier, attaching additional metal nanoparticles to the metal nanostructure treated with the second surface modifier by dipping the metal nanostructure into the metal solution, and increasing a size of the metal nanostructure by annealing the additional metal nanoparticles attached to the metal nanostructure.

The attaching may include forming an APMES reactive group on the surface of the optical fiber by treating the surface of the optical fiber with the APMES.

The removing may include removing the APMES reactive group existing on the surface of the optical fiber using a sodium hydroxide (NaOH) solution.

The removing may include removing the APMES reactive group existing on the surface of the optical fiber through plasma treatment.

The treating may include treating the metal nanostructure formed on the surface of the optical fiber with cysteine to form an amine group on the surface of the metal nanostructure.

According to an aspect, there is provided a fiber-optic localized surface plasmon resonance (FO LSPR) sensor including an optical fiber, and a multi-nanogap structure formed on a surface of the optical fiber. The multi-nanogap structure is formed by attaching metal nanoparticles having a first size to a surface of an optical fiber treated with a first surface modifier by dipping the surface of the optical fiber into a first metal solution, forming a metal nanostructure by annealing the metal nanoparticles having the first size attached to the surface of the optical fiber, removing the first surface modifier existing on the surface of the optical fiber after the metal nanostructure is formed, through chemical treatment and/or physical treatment, treating the metal nanostructure formed on the surface of the optical fiber with a second surface modifier, and dipping the metal nanostructure treated with the second surface modifier into a second metal solution and attaching metal nanoparticles having a second size to the metal nanostructure.

Additional aspects of embodiments will be set forth in part in the description which follows and, in part, will be apparent from the description, or may be learned by practice of the disclosure.

According to an embodiment, a multi-nanogap structure may be fabricated by forming a metal nanostructure on a surface of an optical fiber through an annealing process and introducing the formed metal nanostructure and metal nanoparticles having different sizes.

According to an embodiment, a size and arrangement of a metal nanostructure formed on a surface of an optical fiber may be uniformly adjusted through a multi-step annealing process.

According to an embodiment, the cost may be reduced by simplifying the process for fabricating a metal nanostructure through a short-time annealing process.

According to an embodiment, by fabricating a metal nanostructure as a monomer through an annealing process, a full width at half maximum (FWHM) of a FO LSPR sensor may be reduced, thereby improving the accuracy and reliability of the sensor.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a flowchart illustrating a first fabrication method of a metal nanostructure according to an embodiment;

FIG. 2 is a diagram of an example illustrating a first fabrication method of a metal nanostructure according to an embodiment;

FIG. 3 is a flowchart illustrating a second fabrication method of a metal nanostructure according to an embodiment;

FIG. 4 is a diagram of an example illustrating a second fabrication method of a metal nanostructure according to an embodiment;

FIG. 5 is a diagram illustrating a configuration of an electronic device that performs a first fabrication method and a second fabrication method of a metal nanostructure according to an embodiment;

FIG. 6 is a schematic diagram of an optical fiber-based optical system using a fiber-optic localized surface plasmon resonance (FO LSPR) sensor according to an embodiment;

FIG. 7 is a diagram illustrating a first feature of a FO LSPR sensor according to an embodiment;

FIG. 8 is a diagram illustrating a second feature of a FO LSPR sensor according to an embodiment;

FIG. 9 is a diagram illustrating a third feature of a FO LSPR sensor according to an embodiment; and

FIG. 10 is a diagram illustrating an actually fabricated multi-nanogap structure and COMSOL simulation results according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

As used herein, "A or B", "at least one of A and B", "at least one of A or B", "A, B or C", "at least one of A, B and C", "at least one of A, B, or C", and "one or a combination of at least two of A, B, and C," each of which may include any one of the items listed together in the corresponding one of the phrases, or all possible combinations thereof. Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is "connected," "coupled," or "joined" to another component, a third component may be "connected," "coupled," and "joined" between the first and second components, although the first component may be directly connected, coupled, or joined to the second component.

The singular forms "a," "an," and "the" are intended to include the plural forms as well, unless the context clearly indicates otherwise. It will be further understood that the terms "comprises/including" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

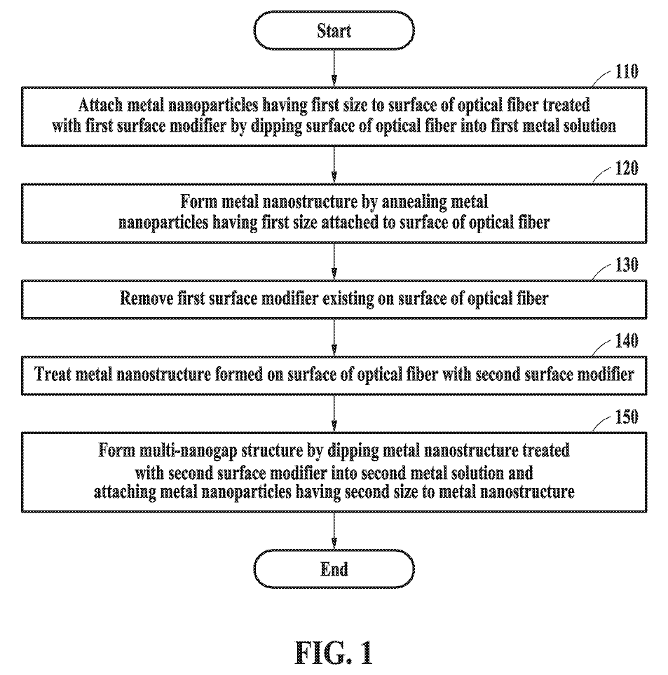

FIG. 1 is a flowchart illustrating a first fabrication method of a metal nanostructure according to an embodiment. In an embodiment, at least one of the operations of FIG. 1 may be simultaneously or parallelly performed with one another, and the order of the operations may be changed. In addition, at least one of the operations may be omitted, or another operation may be additionally performed.

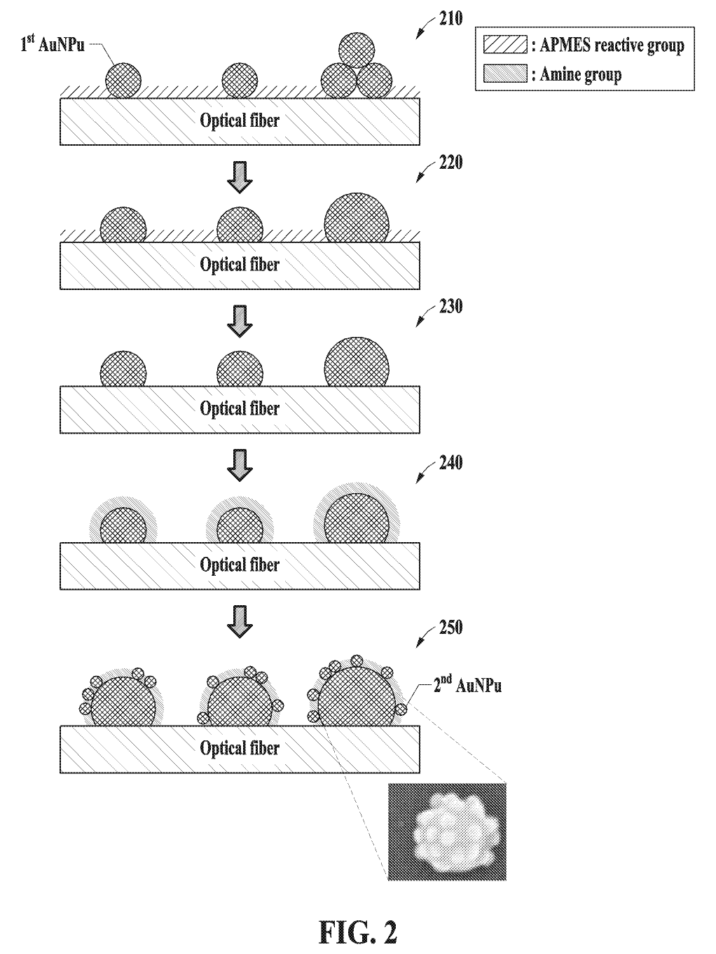

Referring to FIG. 1, in operation 110, a surface of an optical fiber treated with a first surface modifier may be dipped into a first metal solution, so that metal nanoparticles having a first size (e.g., 1^{st} AuNPs) may be uniformly attached to the surface of the optical fiber, as shown in a diagram 210 of FIG. 2.

According to an embodiment, the first surface modifier may be 3-aminopropylmethyldiethoxysilane (APMES), but the type of the first surface modifier is merely an example and is not limited to the above example. The APMES may introduce an APMES reactive group (e.g., an amine group (-NH₂)) to the surface of the optical fiber through chemical modification of the surface of the optical fiber. Herein, the term “APMES reactive group” refers to a functional group introduced by APMES such as the amine group (-NH₂). The APMES reactive group introduced in this way may promote the attachment of metal nanoparticles having the first size to the surface of the optical fiber.

According to an embodiment, the first metal solution may be a gold (Au) solution, and the gold solution may include gold nanoparticles (AuNPs). The gold nanoparticles may be stably attached to the surface of the optical fiber by being bound with the APMES reactive group introduced by the first surface modifier. However, the type of the first metal solution is merely an example and is not limited to the above example.

The attachment process of the metal nanoparticles having the first size may be controlled by at least one variable among a concentration, a temperature, and a dipping time of the first metal solution. For example, as the concentration of the first metal solution is high or the dipping time is long, the metal nanoparticles having the first size may be attached to the surface of the optical fiber with a high density, and the adhesion strength of the metal nanoparticles to the surface of the optical fiber may be increased by controlling the temperature, thereby improving the durability and stability of a sensor.

In operation 120, the metal nanoparticles having the first size attached to the surface of the optical fiber may be annealed to form a metal nanostructure as shown in a diagram 220 of FIG. 2. In the disclosure, by applying a particle-based short-time annealing technology, a faster process time may be provided than in a furnace-based method of the related art, and there may be no need to provide additional semiconductor process equipment such as a clean room or deposition equipment.

In the disclosure, heat may be instantaneously applied only to a localized area through such a short-time annealing technology, thereby effectively forming a metal nanostructure even on a heat-sensitive substrate or device.

In operation 130, after the metal nanostructure is formed, the first surface modifier existing on the surface of the optical fiber may be removed as shown in a diagram 230 of FIG. 2. The first surface modifier (e.g., APMES) may play a role for promoting the attachment of the metal nanoparticles having the first size to the surface of the optical fiber.

However, if the first surface modifier remains, subsequently introduced metal nanoparticles having a second size may also attach to the surface of the optical fiber. Therefore, a removal process of the first surface modifier suppresses reactivity of the surface of the optical fiber, thereby preventing the metal nanoparticles having the second size from being attached to the surface of the optical fiber.

In an embodiment, the first surface modifier may be removed through chemical treatment. For example, the APMES reactive group existing on the surface of the optical fiber may be decomposed and removed by an alkaline solution (e.g., 1 mM NaOH). However, the chemical treatment method for removing the APMES reactive group existing on the surface of the optical fiber is merely an example and is not limited to the above example.

In an embodiment, the first surface modifier may be removed through physical treatment. For example, the APMES reactive group existing on the surface of the optical fiber may be decomposed and removed through plasma surface treatment. However, the physical treatment method for removing the APMES reactive group existing on the surface of the optical fiber is merely an example and is not limited to the above example.

In operation 140, the metal nanostructure formed on the surface of the optical fiber may be treated with a second surface modifier as shown in a diagram 240 of FIG. 2. The second surface modifier may be used to adjust the surface properties of the metal nanostructure to enhance the reactivity for attaching metal nanoparticles having a second size to the metal nanostructure.

In an embodiment, the second surface modifier may be a thiol-amine0based compound, such as cysteamine. In the disclosure, the metal nanostructure may be dipped in a cysteamine solution for a preset dipping time (e.g., 1 hour) to form an amine group (-NH₂) on the surface of the metal nanostructure. The amine group formed in this way may promote the binding of the metal nanoparticles having the second size in a subsequent operation.

Meanwhile, in the disclosure, an operation of washing the surface of the metal nanostructure with deionized water (DI water) may be performed before treating the metal nanostructure with the second surface modifier. In the disclosure, impurities and unreacted modifiers remaining on the surface of the metal nanostructure may be removed through deionized water washing, thereby allowing the second surface modifier to be more uniformly applied to the surface of a metal nanostructure. However, the washing operation of the deionized water may be omitted, if necessary.

In operation 150, the metal nanostructure treated with the second surface modifier may be dipped in a second metal solution to attach the metal nanoparticles having the second size (e.g., 2^{nd} AuNPs) to the metal nanostructure, thereby forming a multi-nanogap structure as shown in a diagram 250 of FIG. 2. At this time, the amine group formed by the second surface modifier may assist in the attachment of the metal nanoparticles having the second size to the metal nanostructure. For example, the second metal solution may contain metal nanoparticles having a smaller size than the first metal solution used in operation 110. Alternatively, the second metal solution may contain the same type of metal nanoparticles as the first metal solution, but this is merely an example. The second metal solution may also contain different types of metal nanoparticles (e.g., silver (Ag) nanoparticles, copper (Cu) nanoparticles, platinum (Pt) nanoparticles, and the like).

The multi-nanogap structure may provide a signal amplification effect due to a hotspot effect caused by microscopic gaps between particles, thereby improving the sensitivity of a fiber-optic localized surface plasmon resonance (FO LSPR) sensor generated using the multi-nanogap structure.

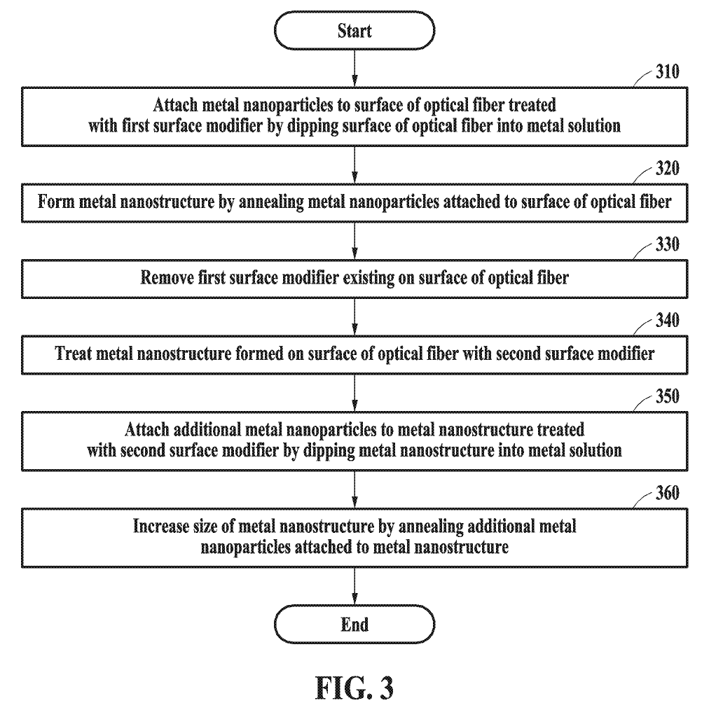

FIG. 3 is a flowchart illustrating a second fabrication method of a metal nanostructure according to an embodiment. In an embodiment, at least one of the operations of FIG. 3 may be simultaneously or parallelly performed with one another, and the order of the operations may be changed. In addition, at least one of the operations may be omitted, or another operation may be additionally performed.

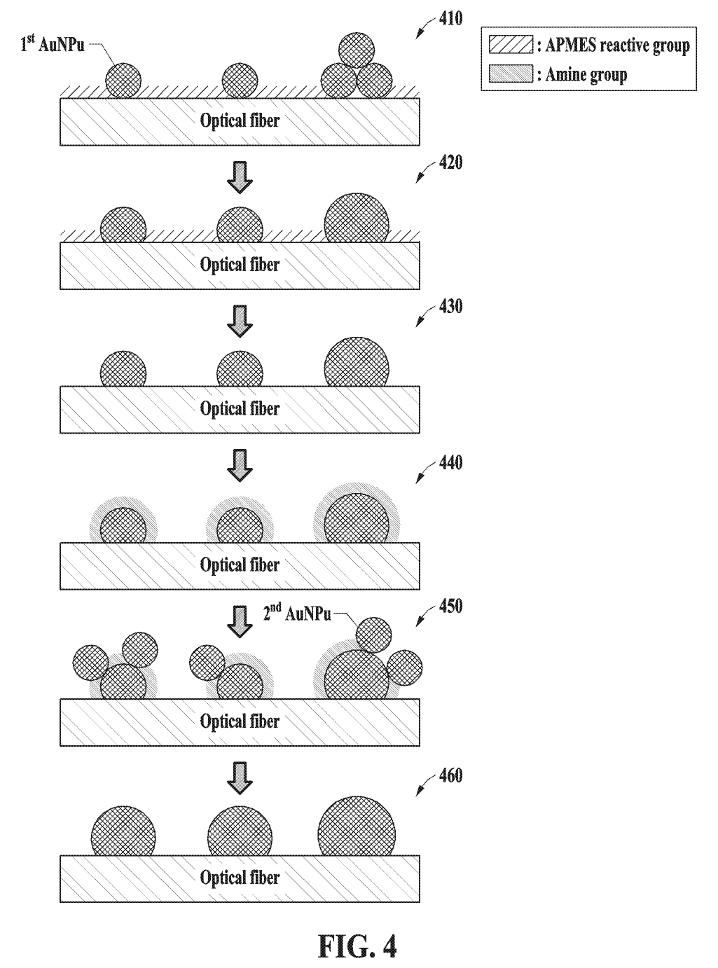

Referring to FIG. 3, in operation 310, a surface of an optical fiber treated with a first surface modifier may be dipped into a metal solution, so that metal nanoparticles (e.g., 1^{st} AuNPs) may be uniformly attached to the surface of the optical fiber, as shown in a diagram 410 of FIG. 4.

According to an embodiment, the first surface modifier may be APMES, but the type of the first surface modifier is merely an example and is not limited to the above example. The APMES may introduce an APMES reactive group (e.g., an amine group (-NH₂)) to the surface of the optical fiber through chemical modification of the surface of the optical fiber. The APMES reactive group introduced in this way may promote the attachment of metal nanoparticles to the surface of the optical fiber.

According to an embodiment, the metal solution may be a gold (Au) solution, and the gold solution may include gold nanoparticles (AuNPs). The gold nanoparticles may be stably attached to the surface of the optical fiber by being bound with the APMES reactive group introduced by the first surface modifier. However, the type of the metal solution is merely an example and is not limited to the above example.

The attachment process of the metal nanoparticles may be controlled by at least one variable among a concentration, a temperature, and a dipping time of the metal solution. For example, as the concentration of the metal solution is high or the dipping time is long, the metal nanoparticles may be attached to the surface of the optical fiber with a high density. The adhesion strength of the metal nanoparticles may be increased as the temperature increases, thereby improving the durability and stability of a sensor.

In operation 320, the metal nanoparticles attached to the surface of the optical fiber may be annealed to form a metal nanostructure as shown in a diagram 420 of FIG. 4. In the disclosure, by applying a particle-based short-time annealing technology, a faster process time may be provided than in a furnace-based method of the related art, and there may be no need to provide additional semiconductor process equipment such as a clean room or deposition equipment.

In the disclosure, heat may be instantaneously applied only to a localized area through such a short-time annealing technology, thereby effectively forming a metal nanostructure even on a heat-sensitive substrate or device.

In operation 330, after the metal nanostructure is formed, the first surface modifier existing on the surface of the optical fiber may be removed as shown in a diagram 430 of FIG. 4. The first surface modifier (e.g., APMES) may play a role for promoting the attachment of the metal nanoparticles to the surface of the optical fiber.

However, if the first surface modifier remains, subsequently introduced additional metal nanoparticles may also attach to the surface of the optical fiber. Therefore, a removal process of the first surface modifier suppresses reactivity of the surface of the optical fiber, thereby preventing the additional metal nanoparticles from being attached to the surface of the optical fiber.

In an embodiment, the first surface modifier may be removed through chemical treatment. For example, the APMES reactive group existing on the surface of the optical fiber may be decomposed and removed by an alkaline solution (e.g., 1 mM NaOH). However, the chemical treatment method for removing the APMES reactive group existing on the surface of the optical fiber is merely an example and is not limited to the above example.

In an embodiment, the first surface modifier may be removed through physical treatment. For example, the APMES reactive group existing on the surface of the optical fiber may be decomposed and removed through plasma surface treatment. The physical treatment method for removing the APMES reactive group existing on the surface of the optical fiber is merely an example and is not limited to the above example.

In operation 340, the metal nanostructure formed on the surface of the optical fiber may be treated with a second surface modifier as shown in a diagram 440 of FIG. 4. The second surface modifier may be used to adjust the surface properties of the metal nanostructure to enhance the reactivity for attaching additional metal nanoparticles to the metal nanostructure.

In an embodiment, the second surface modifier may be a thiol-amine0based compound, such as cysteamine. In the disclosure, the metal nanostructure may be dipped in a cysteamine solution for a preset dipping time (e.g., 1 hour) to form an amine group (-NH₂) on the surface of the metal nanostructure. The amine group formed in this way may promote the binding of the metal nanoparticles in a subsequent operation.

Meanwhile, in the disclosure, an operation of washing the surface of the metal nanostructure with deionized water (DI water) may be performed before treating the metal nanostructure with the second surface modifier. In the disclosure, impurities and unreacted modifiers remaining on the surface of the metal nanostructure may be removed through deionized water washing, thereby allowing the second surface modifier to be more uniformly applied to the surface of a metal nanostructure. However, the washing operation of the deionized water may be omitted, if necessary.

In operation 350, the metal nanostructure treated with the second surface modifier may be dipped in a metal solution to attach the additional metal nanoparticles (e.g., 2^{nd} AuNPs) to the metal nanostructure, as shown in a diagram 450 of FIG. 4. At this time, the amine group formed by the second surface modifier may assist in the attachment of the metal nanoparticles to the metal nanostructure. For example, the metal solution may be the same as the metal solution used in operation 310, and this is merely an example. A metal solution containing different types of metal nanoparticles (e.g., silver (Ag) nanoparticles, copper (Cu) nanoparticles, platinum (Pt) nanoparticles, and the like) may be used.

In operation 360, additional metal nanoparticles attached to the metal nanostructure may be annealed to increase the size of the metal nanostructure as shown in a diagram 460 of FIG. 4. Such metal nanostructure with the increased size provides a larger surface area, which may enhance the sensitivity of a FO LSPR sensor generated using the metal nanostructure. The increased surface area may enhance optical responsivity of the FO LSPR sensor and maximize the interaction with an analyte (e.g., protein, biomarker, chemical, or the like), thereby lowering a signal detection limit.

In addition, the binding between the metal nanostructure and additional metal nanoparticles through the annealing may be strengthened, thereby enhancing the durability of the FO LSPR sensor against physical washing or external environmental changes (e.g., a temperature change, humidity change, or the like). Enhanced binding strength may ensure the long-term stability of the sensor and improve reliability in real-world environments.

Meanwhile, in the disclosure, a metal nanostructure with a desired size may be formed by repeating operations 340 to 360. For example, herein, the size and shape of metal nanostructure may be finely adjusted through repeated processes of the attachment and annealing of additional metal nanoparticles, thereby ensuring sensor performance optimized for a specific application environment.

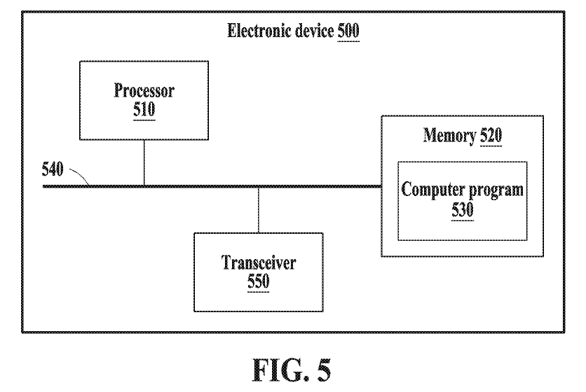

FIG. 5 is a diagram illustrating a configuration of an electronic device that performs a first fabrication method and a second fabrication method of a metal nanostructure according to an embodiment.

An electronic device 500 is disposed inside or outside a multi-nanogap structure fabrication apparatus for forming a multi-nanogap structure on a surface of an optical fiber to control the operations of the multi-nanogap structure fabrication apparatus, thereby forming a multi-nanogap structure optimized for a specific application environment.

Referring to FIG. 5, the electronic device 500 may include at least one processor 510 and a memory 520 configured to load or store a computer program 530 executed by the processor 510. The processor 510 and the memory 520 may be connected to each other via a communication link 540 (e.g., a bus). Optionally, the electronic device 500 may further include a transceiver 550 and the transceiver 550 may be used for data exchange, such as transmission and/or reception of data between the electronic device 500 and another electronic device. The components included in the electronic device 500 of FIG. 5 are just an example, and one of ordinary skill in the art may understand that general components other than the components shown in FIG. 5 may be further included.

The processor 510 may control the overall operation of each component of the electronic device 500. The processor 510 may be implemented as circuitry (e.g., processing circuitry) such as a system on chip (SoC) or an integrated circuit (IC). The processor 510 may include one or more processors. For example, the processor 510 may include a combination of one or more processors, such as a central processing unit (CPU), a microprocessor unit (MPU), a microcontroller unit (MCU), a graphic processing unit (GPU), a neural processing unit (NPU), a digital signal processor (DSP), an application processor (AP), a communication processor (CP), or any other processors well known in the technical field of the disclosure. In addition, the processor 510 may perform an operation on the computer program 530 or at least one application to execute a method and/or an operation according to various examples of the disclosure.

The memory 520 may store one of or a combination of two or more of various pieces of data, instructions, or information used by a component (e.g., the processor 510) included in the electronic device 500. The memory 520 may include volatile memory and/or non-volatile memory.

The computer program 530 may include one or more actions through which the methods/operations described herein according to examples are implemented and may be stored in the memory 520 as software. In this case, the action may correspond to an instruction that is implemented in the program 530. For example, the computer program 530 may include instructions for controlling a metal nanostructure fabrication apparatus to perform attaching metal nanoparticles having a first size to a surface of an optical fiber treated with a first surface modifier by dipping the surface of the optical fiber into a first metal solution, forming a metal nanostructure by annealing the metal nanoparticles having the first size attached to the surface of the optical fiber, removing the first surface modifier existing on the surface of the optical fiber after the metal nanostructure is formed, through chemical treatment and/or physical treatment, treating the metal nanostructure formed on the surface of the optical fiber with a second surface modifier, and forming a multi-nanogap structure by dipping the metal nanostructure treated with the second surface modifier into a second metal solution and attaching metal nanoparticles having a second size to the metal nanostructure.

When the computer program 530 is loaded to the memory 520, the processor 510 may execute various methods and/or operations according to various embodiments of the disclosure by executing a plurality of operations to implement the computer program 530.

The communication link 540 may include a path to transmit various pieces of data, instructions, and information among components included in the electronic device 500. The communication link 540 may be, for example, a peripheral component interconnect (PCI) bus or an extended industry standard architecture (EISA) bus. However, the type of the bus is an example and is not limited thereto. For example, a bus is illustrated by a single line for ease of description in FIG. 5, but a plurality of buses or various types of buses may be included.

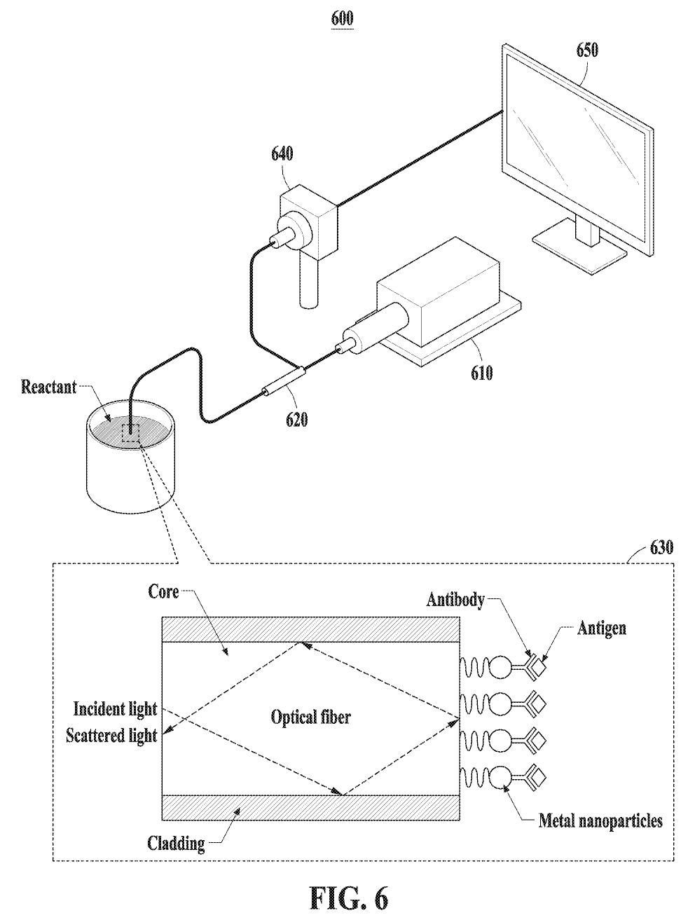

FIG. 6 is a schematic diagram of an optical fiber-based optical system using a FO LSPR sensor according to an embodiment.

Referring to FIG. 6, an optical fiber-based optical system 600 may include at least one of a light source 610, an optical fiber coupler 620, a FO LSPR sensor 630, a detector 640, and an analysis apparatus 650.

The optical fiber-based optical system 600 may allow an optical signal emitted from the light source 610 to be incident on a surface of the FO LSPR sensor 630 through the optical fiber coupler 620. At this time, the FO LSPR sensor 630 may form a multi-nanogap structure on the surface of the optical fiber, and the surface of the multi-nanogap structure may have a fixed target substance (e.g., an antibody, DNA, protein, or the like) to induce the binding with an analysis target substance (e.g., a specific antigen).

More specifically, the optical signal emitted from the light source 610 may interact with the multi-nanogap structure formed on the surface of the FO LSPR sensor 630 to generate localized surface plasmon resonance (LSPR) at a specific wavelength.

At this time, when the target substance existing on the surface of the multi-nanogap structure and the analysis target substance are bound by the LSPR, a change in the surface refractive index occurs, which may change intensity and a resonance wavelength of the optical signal reflected from the surface of the optical fiber.

Such a change is transmitted to the detector 640 through the optical fiber coupler 620, and the detector 640 may measure the change in the reflected optical signal, convert the change into an electrical signal, and then transmit the electrical signal to the analysis apparatus 650.

The analysis apparatus 650 may analyze a degree of reaction (e.g., adsorption amount of antigen) by comparing and analyzing an initial reaction signal (e.g., before the antigen is bound) of the FO LSPR sensor 630 with a reaction signal after the analysis target substance is bound, using the data transmitted from the detector 640.

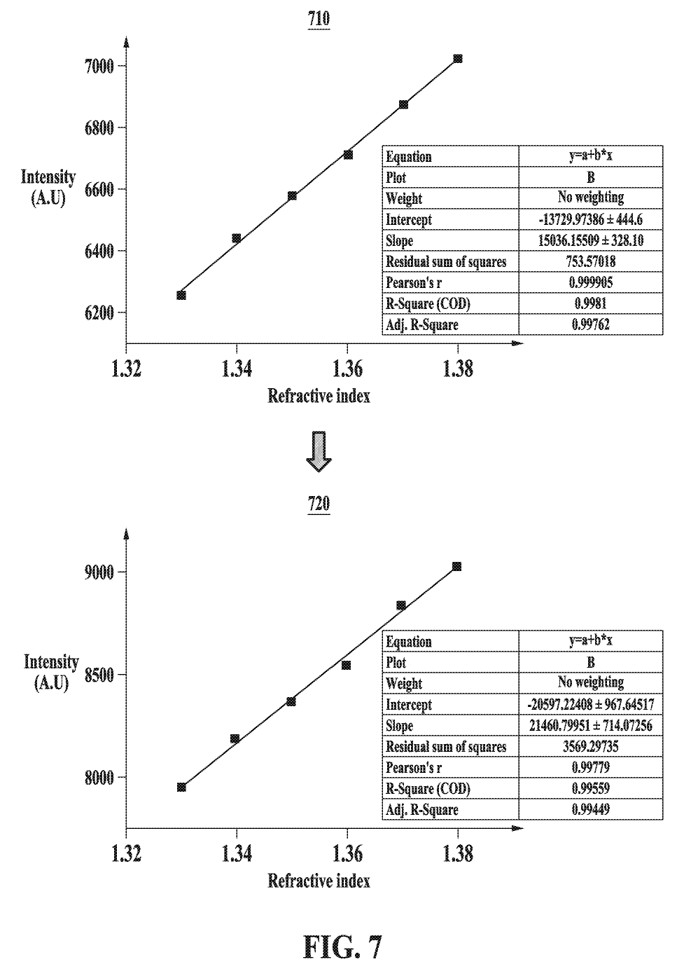

FIG. 7 is a diagram illustrating a first feature of a FO LSPR sensor according to an embodiment.

According to an embodiment, a FO LSPR sensor generated using the annealing process provided herein may have improved detection sensitivity compared to a FO LSPR sensor of the existing particle method (e.g., an electrostatic binding method, solution dipping method, deposition method, or the like).

Referring to FIG. 7, the detection sensitivity (slope) of the FO LSPR sensor of the existing particle method is 15,036 as shown in a first graph 710, however, the detection sensitivity of the FO LSPR sensor provided herein has increased to 21,460 as shown in a second graph 720, which is an improvement of about 42.8%. When the detection sensitivity of the FO LSPR sensor increases in this way, the analysis target substance having a lower concentration may be detected, which may significantly improve diagnostic performance.

In addition, referring to FIG. 7, it may be confirmed that an R-Square value indicating a coefficient of determination (COD) and a Pearson's r value indicating a Pearson correlation coefficient are both 0.99 or higher for both of the FO LSPR sensor provided herein and the FO LSPR sensor of the existing particle method, which may imply that the linearity between signal intensity and a refractive index of the FO LSPR sensor is high, and thus the reliability of the experimental results is excellent.

In addition, according to an embodiment, the FO LSPR sensor generated using the annealing process provided herein may have a reduced full width at half maximum (FWHM) compared to the FO LSPR sensor of the existing particle method. At this time, the reduction of the FWHM may imply that the optical signal may be measured more clearly and precisely in the FO LSPR sensor, which may imply that a signal-to-noise ratio (SNR) is improved, thereby increasing the accuracy and reproducibility of diagnostic performance.

Therefore, the FO LSPR sensor using the annealing process provided herein may provide high detection sensitivity and excellent signal quality compared to the existing particle method, and thus may be utilized in various application fields such as medical diagnosis, environmental monitoring, and biochemical analysis.

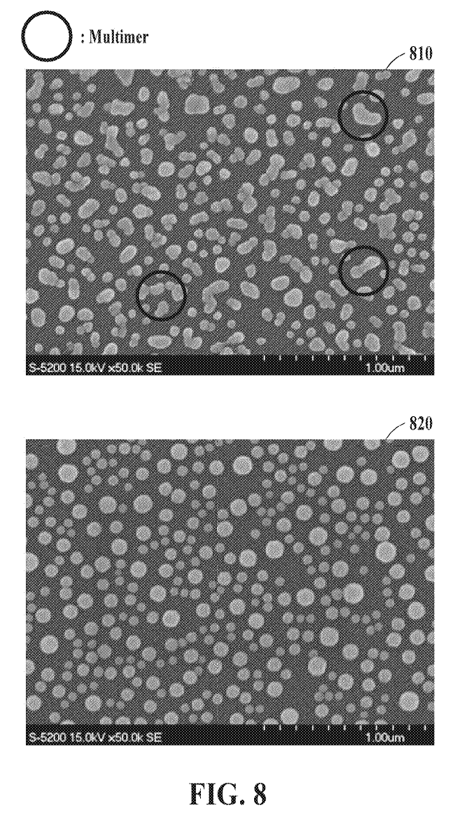

FIG. 8 is a diagram illustrating a second feature of a FO LSPR sensor according to an embodiment.

Referring to a diagram 810 of FIG. 8, in a FO LSPR sensor using the existing electrostatic binding method, a plurality of metal nanostructures formed in a multimer may exist on a surface of the sensor during the fabrication process. The formation of the multimer may degrade the optical signal quality of the FO LSPR sensor, causing an increase in the FWHM in the spectrum.

Referring to a diagram 820 of FIG. 8, in the FO LSPR sensor generated using the annealing process provided herein, metal nanostructures may exist in the form of monomers on the surface of the sensor during the fabrication process. This may reduce the FWHM of the FO LSPR sensor, thereby improving the signal quality.

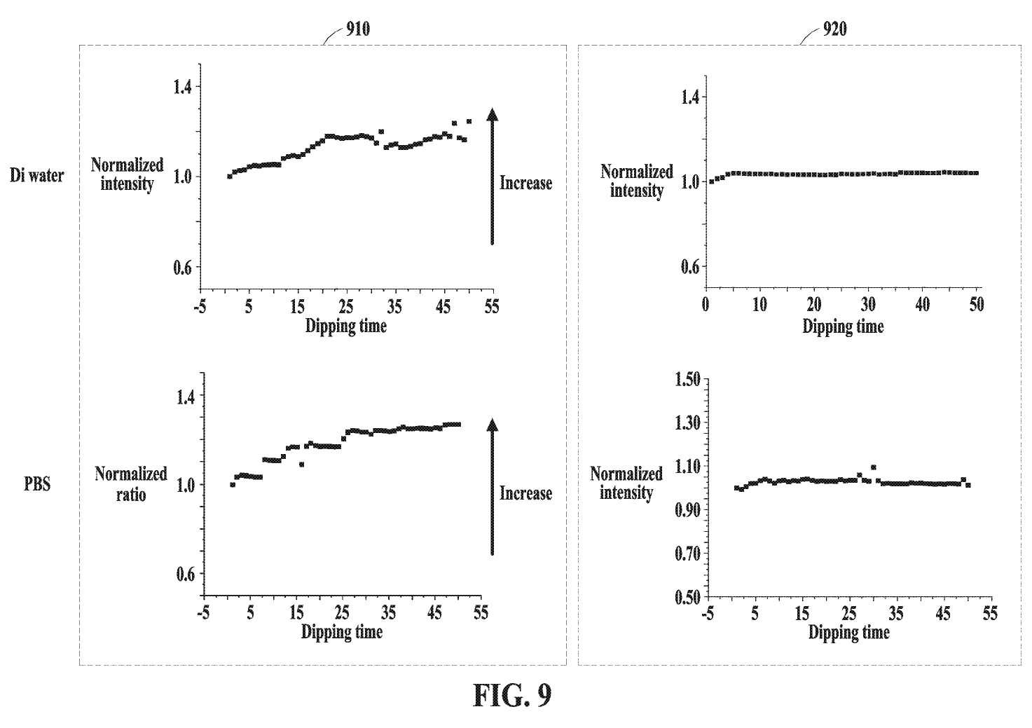

FIG. 9 is a diagram illustrating a third feature of a FO LSPR sensor according to an embodiment.

Referring to a diagram 910 of FIG. 9, for the FO LSPR sensor manufactured using the existing electrostatic binding method, it may be observed that an output signal of the sensor gradually increases in repeated dipping experiments in DI water and a phosphate buffer solution (PBS). This may cause signal instability as the metal nanoparticles on the surface of the sensor are gradually rearranged or new particles are adsorbed, which may reduce reliability in real-world environments.

Referring to a diagram 920 of FIG. 9, for the FO LSPR sensor generated using the annealing process provided herein, it may be observed that there is almost no change in the output signal of the sensor even in the same repeated dipping experiment. This is because the adhesion strength of the metal nanoparticles increases through the annealing process and the structure between the metal nanoparticles is fixed, thereby providing a stable signal output.

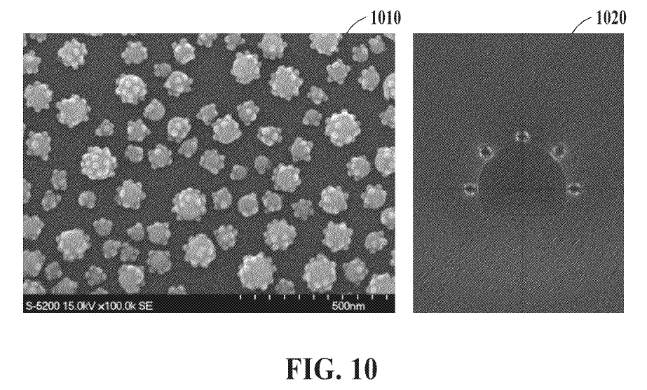

FIG. 10 is a diagram illustrating an actually fabricated multi-nanogap structure and COMSOL simulation results according to an embodiment.

Referring to a diagram 1010 of FIG. 10, it may be confirmed that the multi-nanogap structure is formed in a uniform shape and shows a consistent pattern in shape and size. This is achieved through a precise annealing process and particle arrangement process, eliminating the unevenness in shape and size that may occur with the existing method.

Referring to a diagram 1020 of FIG. 10, the results of the COMSOL simulation may show a hotspot effect occurring between particles forming the multi-nanogap structure. The hotspot effect occurring in the multi-nanogap structure may maximize the detection sensitivity of the FO LSPR sensor, enabling accurate detection of even the analysis target substance with minute concentration.

The embodiments described herein may be implemented using a hardware component, a software component and/or a combination thereof. A processing device may be implemented using one or more general-purpose or special-purpose computers, such as, for example, a processor, a controller, an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

This application was supported by a research project from the Ministry of Trade, Industry and Energy of the Republic of Korea and managed by the Korea Planning & Evaluation Institute of Industrial Technology. (Research Business Name: Materials and Components Technology Development Program; Research Project Name: Development of FO LSPR material components for high sensitivity biosensing; Project No.: 00507794; Project Unique Identifier: 2410012158; Project Executing Agency: ctnetworks; Research Period: 2025-04-01 ~ 2025-12-31).

What is claimed is:

1. A method of fabricating a metal nanostructure, the method comprising:
attaching metal nanoparticles having a first size to a surface of an optical fiber treated with a first surface modifier by dipping the surface of the optical fiber into a first metal solution;
forming a metal nanostructure by annealing the metal nanoparticles having the first size attached to the surface of the optical fiber;
removing the first surface modifier existing on the surface of the optical fiber after the metal nanostructure is formed, through chemical treatment and/or physical treatment;
treating the metal nanostructure formed on the surface of the optical fiber with a second surface modifier; and
forming a multi-nanogap structure by dipping the metal nanostructure treated with the second surface modifier into a second metal solution and attaching metal nanoparticles having a second size to the metal nanostructure.

2. The method of claim 1, wherein the attaching comprises forming a 3-aminopropylmethyldiethoxysilane (APMES) reactive group on the surface of the optical fiber by treating the surface of the optical fiber with the APMES.

3. The method of claim 2, wherein the removing comprises removing the APMES existing on the surface of the optical fiber using a sodium hydroxide (NaOH) solution.

4. The method of claim 2, wherein the removing comprises removing the APMES existing on the surface of the optical fiber through plasma treatment.

5. The method of claim 1, wherein the treating comprises treating the metal nanostructure formed on the surface of the optical fiber with cysteine to form an amine group on the surface of the metal nanostructure.

6. A method of fabricating a metal nanostructure, the method comprising:
attaching metal nanoparticles to a surface of an optical fiber treated with a first surface modifier by dipping the surface of the optical fiber into a metal solution;
forming a metal nanostructure by annealing the metal nanoparticles attached to the surface of the optical fiber;
removing the first surface modifier existing on the surface of the optical fiber after the metal nanostructure is formed, through chemical treatment and/or physical treatment;
treating the metal nanostructure formed on the surface of the optical fiber with a second surface modifier;
attaching additional metal nanoparticles to the metal nanostructure treated with the second surface modifier by dipping the metal nanostructure into the metal solution; and
increasing a size of the metal nanostructure by annealing the additional metal nanoparticles attached to the metal nanostructure.

7. The method of claim 6, wherein the attaching comprises forming a 3-aminopropylmethyldiethoxysilane (APMES) reactive group on the surface of the optical fiber by treating the surface of the optical fiber with the APMES.

8. The method of claim 6, wherein the removing comprises removing the APMES reactive group existing on the surface of the optical fiber using a sodium hydroxide (NaOH) solution.

9. The method of claim 6, wherein the removing comprises removing the APMES reactive group existing on the surface of the optical fiber through plasma treatment.

10. The method of claim 6, wherein the treating comprises treating the metal nanostructure formed on the surface of the optical fiber with cysteine to form an amine group on the surface of the metal nanostructure.

11. A fiber-optic localized surface plasmon resonance (FO LSPR) sensor comprising:
an optical fiber; and
a multi-nanogap structure formed on a surface of the optical fiber,
wherein the multi-nanogap structure is formed by attaching metal nanoparticles having a first size to a surface of an optical fiber treated with a first surface modifier by dipping the surface of the optical fiber into a first metal solution, forming a metal nanostructure by annealing the metal nanoparticles having the first size attached to the surface of the optical fiber, removing the first surface modifier existing on the surface of the optical fiber after the metal nanostructure is formed, through chemical treatment and/or physical treatment, treating the metal nanostructure formed on the surface of the optical fiber with a second surface modifier, and dipping the metal nanostructure treated with the second surface modifier into a second metal solution and attaching metal nanoparticles having a second size to the metal nanostructure.
